(19) United States
(12) Patent Application Publication
(10) Pub. No.: US 2014/0214713 A1
(43) Pub. Date: Jul. 31, 2014

(54) ONE-CLICK SHIPPING LABEL PRINTING

(71) Applicant: Badrinath Vengalathur Srinath, Chennai TamilNadu (IN)

(72) Inventor: Badrinath Vengalathur Srinath, Chennai TamilNadu (IN)

(73) Assignee: eBay Inc., San Jose, CA (US)

(21) Appl. No.: 13/794,168

(22) Filed: Mar. 11, 2013

Related U.S. Application Data
(60) Provisional application No. 61/759,010, filed on Jan. 31, 2013.

(51) Int. Cl. G06Q 10/08; G06Q 30/06

(52) U.S. Cl. CPC G06Q 10/083; G06Q 30/06
USPC 705/330

(57) ABSTRACT

A system and method for generating a shipping label are described. A shipping label application stores a shipping preset preference corresponding to an item listed by a seller on the marketplace, the shipping preset preference identifying one of a plurality of shipping carriers and one of a plurality of shipping services selected by the seller for the item. The shipping label application identifies the item in a transaction of the seller in the marketplace, retrieves the shipping preset preference of the seller corresponding to the item, and generates a shipping label for the item based on the shipping preset preference.

### RELATED APPLICATION

This application claims the priority benefit of U.S. Provisional Patent Application No. 61/759,010, filed Jan. 31, 2013, the entirety of which is incorporated herein by reference.

### TECHNICAL FIELD

This application relates generally to the field of computer technology, and in a specific example embodiment, to a one-click shipping label printing system.

### BACKGROUND

Websites provide a number of publishing, listing, and price-setting mechanisms whereby a publisher (e.g., a seller) may list or publish information concerning items for sale. Once a buyer places an order for an item, the seller fulfills the order by shipping the item to the buyer.

Sellers are faced with a variety of tasks when the item ordered is being. Many of the steps may involve selecting and arranging corresponding shipping carriers and services, in addition to filling out various forms, that further complicate and add inefficiency to the process.

### BRIEF DESCRIPTION OF THE DRAWINGS

The present disclosure is illustrated by way of example, and not by way of limitation, in the figures of the accompanying drawings in which:

FIG. 1 is a network diagram depicting a network system, according to one example embodiment, having a client-server architecture configured for exchanging data over a network.

FIG. 2 is a block diagram illustrating one example embodiment of a marketplace application.

FIG. 3 is a block diagram illustrating one example embodiment of a shipping label application.

FIG. 4 is a block diagram illustrating one example embodiment of a shipping preset preferences module.

FIG. 5 is a block diagram illustrating one example embodiment of a shipping label generator.

FIG. 6 is a ladder diagram illustrating one example embodiment of an operation for generating a shipping label.

FIG. 7 is a block diagram illustrating one example embodiment of a table of shipping preset preferences.

FIG. 8 is a flow diagram illustrating one example embodiment of a method for generating a shipping label.

FIG. 9 is a flow diagram illustrating another example embodiment of a method for generating a shipping label.

FIG. 10 shows a diagrammatic representation of a machine in the example form of a computer system within which a set of instructions may be executed to cause the machine to perform any one or more of the methodologies discussed herein.

### DETAILED DESCRIPTION

Although the embodiments of the invention in the present disclosure are described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for generating a shipping label are described. A shipping label application stores a shipping preset preference corresponding to an item listed by a seller on the marketplace. The shipping preset preference identifies one of a plurality of shipping carriers and one of a plurality of shipping services selected by the seller for the item. The shipping label application identifies the item in a transaction of the seller in the marketplace, retrieves the shipping preset preference of the seller corresponding to the item, and generates a shipping label for the item based on the shipping preset preference.

### System Architecture

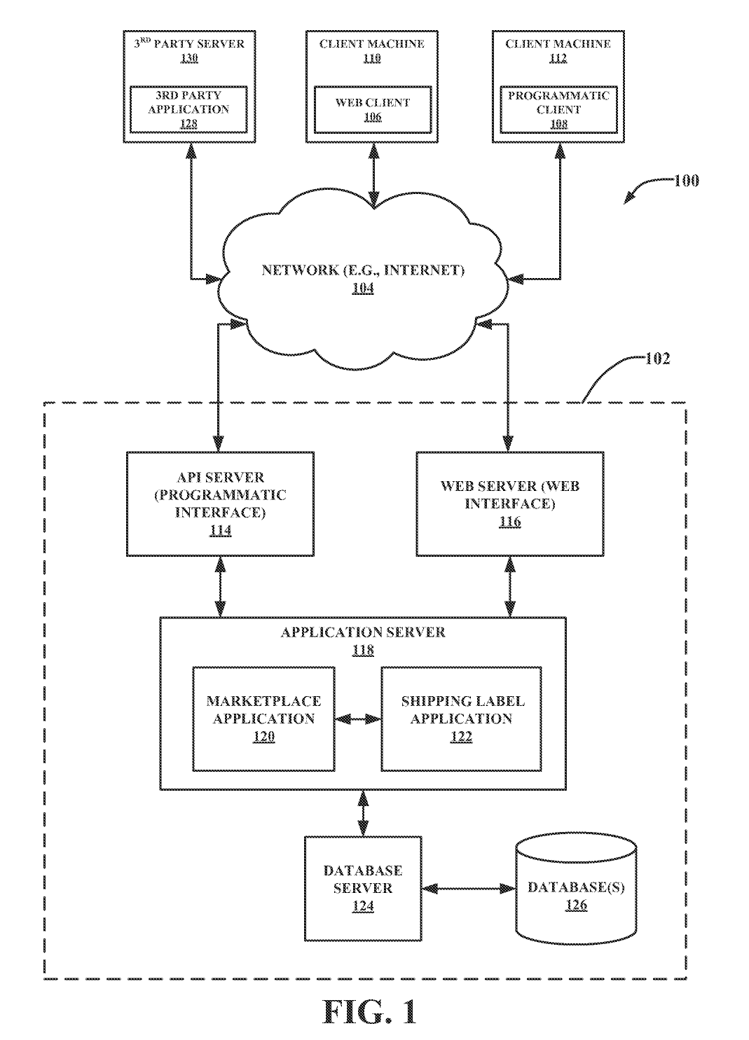

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein is a client-server architecture as an example, other example embodiments may include other network architectures, such as a peer-to-peer or distributed network environment.

A data exchange platform, in an example form of a marketplace application 120 and a shipping label application 122, may provide server-side functionality, via a network 104 (e.g., the Internet) to one or more clients. The one or more clients may include users that utilize the network system 100 and more specifically, the marketplace application 120 and the shipping label application 122, to exchange data over the network 104. These transactions may include communicating (e.g., transmitting, receiving) and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among other things.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third-party server 130 with a third-party application 128. It can be appreciated that in various embodiments the client machines 110, 112, or third-party server 130 may be associated with a buyer, a seller, a third-party electronic commerce platform, a payment service provider, a shipping service provider, a financial institution system, each in communication with the network-based publisher 102 and optionally each other. The buyers and sellers may be any one of individuals, merchants, or service providers, among other things.

Turning specifically to the marketplace application 120 and the shipping label application 122, an application program interface (API) server 114 and a web server 116 are coupled to, and provide programmatic and web interfaces respectively to, one or more application servers 118. The application server(s) 118 hosts one or more marketplace applications 120 and the shipping label application 122. The application server(s) 118 is, in turn, shown to be coupled to one or more database servers 124 that facilitate access to one or more database(s) 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third-party application 128) running on another client machine (e.g., client machine 112 or third-party server 130).

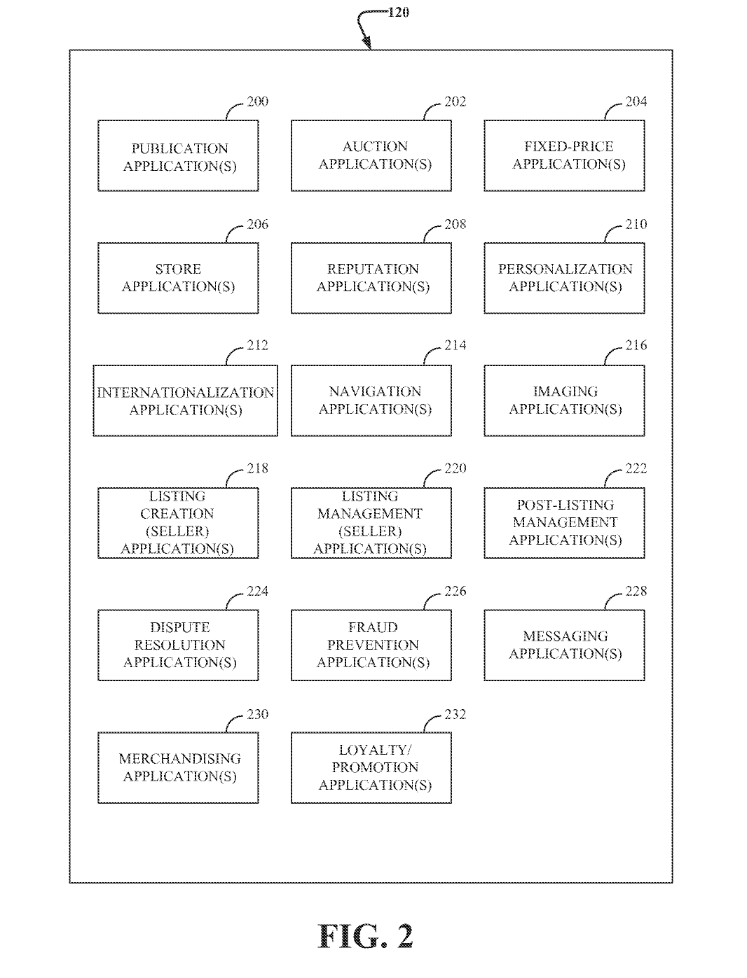

In one embodiment, the marketplace application 120 provides listings and price-setting mechanisms whereby a user may be a seller or buyer who lists or buys goods and services (e.g., for sale) published on the marketplace application 120. The marketplace application 120 is described in more details below with respect to FIG. 2.

In one embodiment, the shipping label application 122 generates a shipping label including customs forms for an item. The shipping label is generated using information from the transaction between the buyer and the seller for an item in the online marketplace. In particular, the seller may be able to print the shipping label using a single action such as one-click and avoid having to go through several dialog boxes asking the seller to select a shipping provider, a service associated with the shipping provider, and other relevant information such as for the customs form.

Thus, the shipping label application 122 enhances the usability of the marketplace application 120's label printing platform by allowing sellers to print shipping labels across multiple carriers and services in just one a single action (e.g., one click) at the client. This makes the process of printing shipping labels easier for the seller and thus might attract more sellers to marketplace platform for printing shipping labels.

Typically, sellers choose for each order, a carrier and a type of shipping service, from a list of carriers and services provided by the carriers before printing a shipping label for the order. For multiple carriers and multiple shipping service platforms, this process can be cumbersome since the seller has to select a carrier and a service associated with the carrier. In one embodiment, this series of steps may be condensed into one step. For example, a tool in the marketplace application include a feature called ‘Preset’ that allows sellers to associate customs information to customs label associated with an order. This feature can be enhanced to allow the seller to also associate carriers and services to a customs label.

Thus, one an order is downloaded into the tool, the seller can generate a shipping label that includes corresponding customs form for the order in response to a single button click from the seller at the client.

The tool may be used for domestic trade and cross-border trade (e.g., shipping internationally). The customs information for an order may be used to fill out a customs form associated with the order. This may be achieved by predefining information for the item in presets. For example, for item x, the predefined information may include a description of the item, a reference number, the item average value, the item range value, a weight of the item, a country of origin (e.g., where it was assembled or manufactured), whether the item can be exempt from customs. The shipping label application 122 may determine based on information from the transaction and the presets whether the item to be shipped is exempts from customs.

Once customs information is filled out in the customs label, the seller chooses a shipping carrier and a shipping service before printing the shipping label.

In one embodiment, the shipping label application associates the shipping carrier and shipping service details to a group of items as part of the presets. Thus, once an order is downloaded into the tool, all that is left for the seller to do is to click a button and print the shipping label including the corresponding customs form. So for example, the shipping label is printed based on a preset shipping selection from the seller based on the item and destination of the item (e.g., for item X to be shipped to country Y, use shipping carrier A and shipping service B).

Sellers provide the following information in the shipping preset preferences and associate the shipping preset preferences with customs information:

Shipping carrier name or identifier (e.g., USPS)

Type of shipping service from the shipping carrier (e.g., Express Mail).

The shipping label application 122 makes it easier and simpler for sellers to print shipping labels including prefilled customs form in a single click.

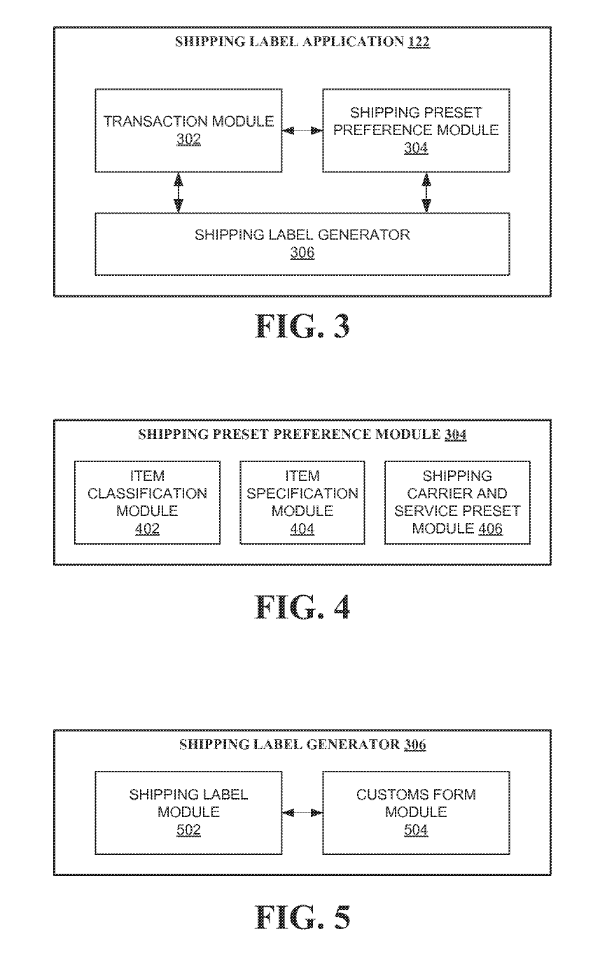

In another embodiment, the shipping label application 122 may be extended to support one-click label printing from mobile devices, thus increasing the speed and ease with which sellers can print shipping labels including corresponding customs forms. This increases the ease and speed and can help increase the number of labels sellers print using the marketplace application 120. Example embodiments of the shipping label application 122 are described in more details below with respect to FIG. 3, FIG. 4, and FIG. 5.

FIG. 2 shows a block diagram illustrating one example embodiment of the marketplace application 120. The market application 120 may be hosted on dedicated or shared server machines (not shown) that are communicatively coupled to enable communications between server machines. The applications 120 and 122 themselves are communicatively coupled (e.g., via appropriate interfaces) to each other and to various data sources, on as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace application 120 is shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

FIG. 3 is a block diagram illustrating one example embodiment of the shipping label application 1122 of FIG. 1. For example, the shipping label application 122 includes a transaction module 302, a shipping preset preference module 304, and a shipping label generator 306.

The transaction module 302 retrieves information from a commercial transaction for an item between a buyer and a seller of the marketplace application 120. For example, the transaction module 302 may identify the item being shipping using for example, an identifier such as an ISBN, a SKU, or a model or serial number of the item. The transaction module 302 may also retrieve the shipping address/shipping origin of the buyer and the shipping address/shipping destination of the seller. The transaction module 302 may also identify the value of the commercial transaction between the buyer and the seller (e.g., item was sold for x US Dollars). In another embodiment, the transaction module 302 may access other information pertinent to the item based on the identifier of the item (e.g., weight, dimensions, description of the item, whether the item is to he quarantined, special handling such as fragile, and so forth).

The shipping preset preferences module 304 may retrieve shipping preset preferences based on the identifier of the item, from a table or database. The shipping preset preference module 304 identifies an item classification for the item, identifies specifications of the item associated with the item classification, and identifies one of a plurality of shipping carriers and one of a plurality of shipping services selected by the seller for the item. For example, the seller may have already identified the item as part of a group of items to be shipped using a specified shipping service provider or carrier and corresponding shipping service.

The shipping label generator 306 may generate a shipping label including customs information based on the information provided by the transaction module 302 and the shipping preset preferences module 304. In one embedment, the shipping label generator 306 generates the shipping label based on the item classification, specifications of the item, for the one of the shipping carriers and one of the shipping services selected by the seller for the item, in response to a single action (e.g., one click) being performed at a client of the seller. The item and value of the item may be included in a customs form based on the retrieved information.

In another embodiment, a seller creates a ‘custom label’ or a group identifier. The group identifier may include SKU (stock keeping unit) information to identify the items the seller has for sale in groups. All items that belong to a sku have the same customs info such as weight, country of origin, etc. While listing the item on the online marketplace, the seller mentions the ‘custom label’ of the item. If the ‘name’ of the preset created in the shipping tool and the name of the ‘custom label’ mentioned in the online marketplace are the same, the tool automatically associates all preset details such as preferred shipping method and customs information to the order.

After this, the seller generate a single action such as clicking a ‘pay for and print’ label button. The shipping tool stores the sellers id and the seller may already have a billing agreement with a financial application associated with the online marketplace, before using the tool. As such, payment with the financial application may happen behind the scenes automatically (e.g., shipping fee may be deducted from the seller using the financial application at the backend).

FIG. 4 is a block diagram illustrating one example embodiment of the shipping preset preference module 304. The shipping preset preference module 304 may include an item classification module 402, an item specification module 404, and a shipping carrier service preset module 406. The item classification module 402 identifies an item classification for the item. An item having an SKU #123 may be part of a group of items identified by the seller to be used with a particular shipping provider and shipping service. The item specification module 404 identifies specifications of the item associated with the item classification or the group of items. The shipping carrier and service preset module 406 identifies one of the shipping carriers and one of the shipping services selected by the seller to be used for shipping the item.

FIG. 5 is a block diagram illustrating one example embodiment of the shipping label generator 306. The shipping label generator 306 may include a shipping label module 502 configured to communicate with corresponding shipping service providers. The customs form module 504 may be configured to retrieve, store, and update customs forms. For example, the customs form module 504 may communicate with servers of customs authorities around the world to obtain the latest forms. Customs forms may be retrieved based on information from the seller and buyer. For example, the customs form module 504 may retrieve Chinese customs forms for a seller in China. Once the customs form module 504 determines which appropriate customs forms to use, the customs form module 504 fills out the corresponding customs forms based on the information of the item from the commercial transaction between the buyer and the seller of the marketplace application 120.

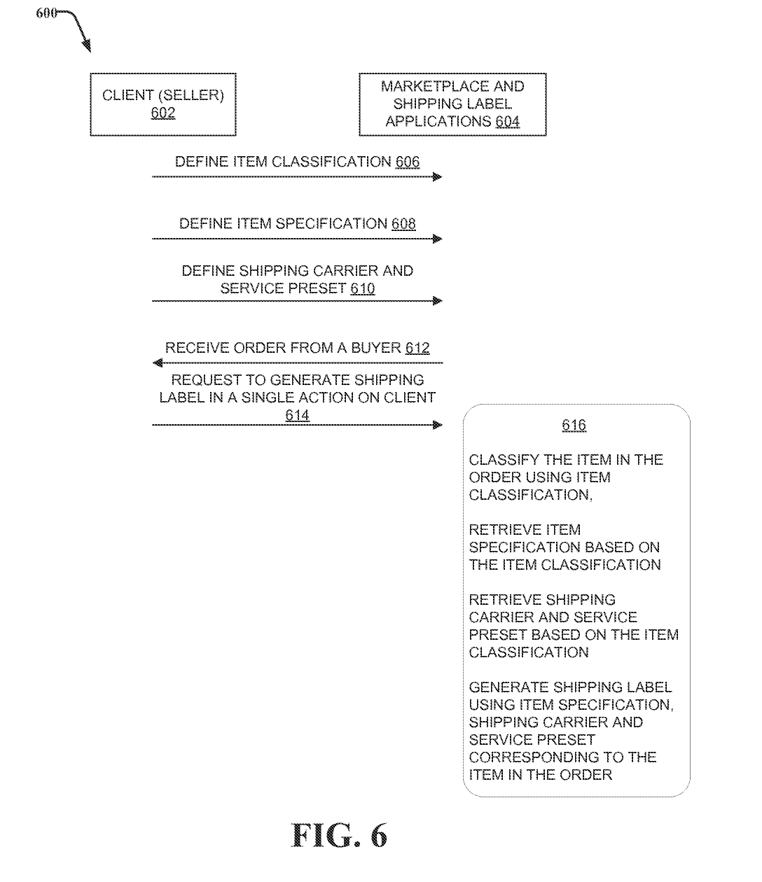

FIG. 6 is a ladder diagram illustrating one example embodiment of an operation 600 for generating a shipping label. A client 602 of a seller communicates with marketplace and shipping label applications 604. At operation 606, the seller defines item classification of items listed for sale by the seller. For example, small MP3 players from brand X may be categorized in a shipping group. At operation 608, the seller further defines specifications of the items belonging to the shipping group. For example, all small MP3 players from the shipping group defined at operation 606 have a value of $x dollars and weight about 10 oz. At operation 610, the seller selects shipping carrier and corresponding shipping service associated with the shipping group.

At operation 612, the seller receives an order from a buyer. At operation 614, the seller submits a request to generate a shipping label to fulfill the order from operation 612. In one embodiment, the seller submits the request to generate the shipping label with the corresponding shipping carrier and service in only one single action on the client (e.g., one click). In order words, the seller does not have to go through a series of dialog box asking to select shipping carriers and services.

At operation 616, the shipping label application classifies the item in the order received at operation 612 using item classification. For example, a red T shirt being ordered is identified as belonging to a group of items A associated with shipping carrier B. The shipping label application retrieves item specification based on the item classification. For example, all T shirts in group of items A have a value of $10 and weight x oz. The shipping label application then retrieves a shipping carrier and shipping preset based on the item classification. For example, all items in group of items A are to be shipping using shipping carrier USPS using two-day shipping service. The shipping label application then generates a shipping label using the item specification, shipping carrier and service preset corresponding to the item in the order.

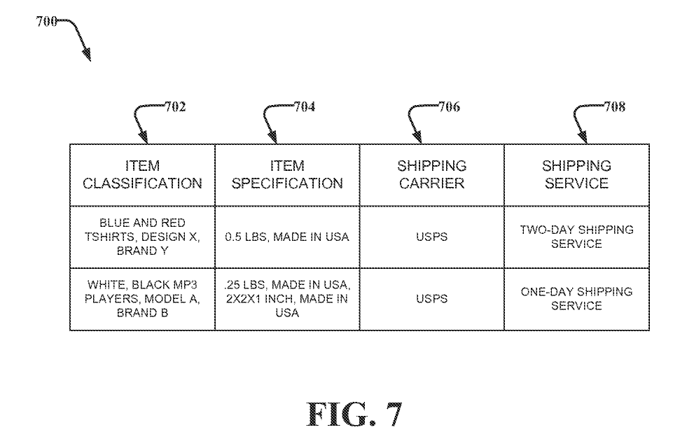

FIG. 7 is a block diagram illustrating one example embodiment of a table 700 of shipping preset preferences. Column 702 identifies an item classification (e.g., blue and red T shirts with design X from brand Y). Column 704 identifies a specification of an item corresponding to the item classification (e.g., weight, country of origin, etc.). Column 706 identifies a shipping carrier or provider (e.g., USPS) to be used to ship an item corresponding to the item classification. Column 707 identifies a shipping service (e.g., two-day shipping) to be used to ship an item corresponding to the item classification.

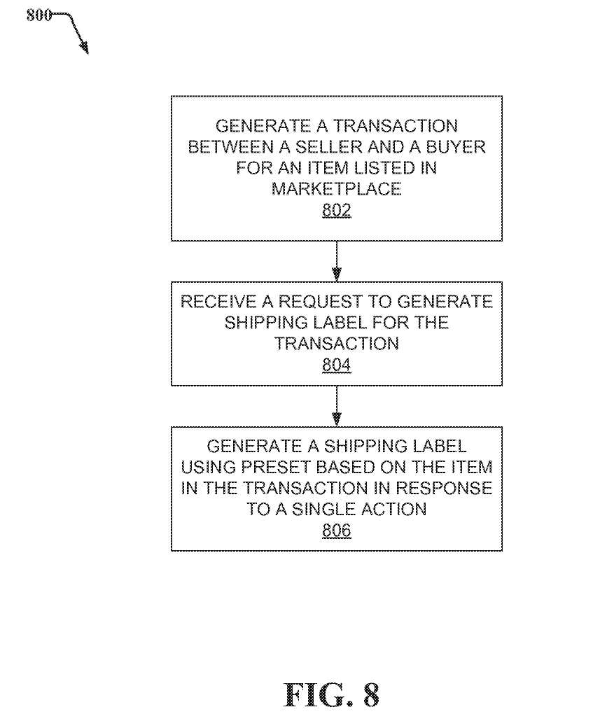

FIG. 8 is a flow diagram illustrating one example embodiment of a method 800 for a generating a shipping label. At operation 802, the marketplace application 120 generates a commercial transaction between a buyer and a seller for an item listed by the seller in the marketplace. For example, the transaction may include a commercial transaction where the buyer has ordered an item from the seller on the online marketplace.

At operation 804, the shipping label application 122 receives a request from the seller to generate a shipping label for the transaction.

At operation 806, the shipping label application 122 generates a shipping label that may also include customs information if the shipping is cross-border. For example, the shipping label may be generated using shipping presets based on the item or a group to which the item belong in the transaction. The group may be defined based on the seller's customization of the group.

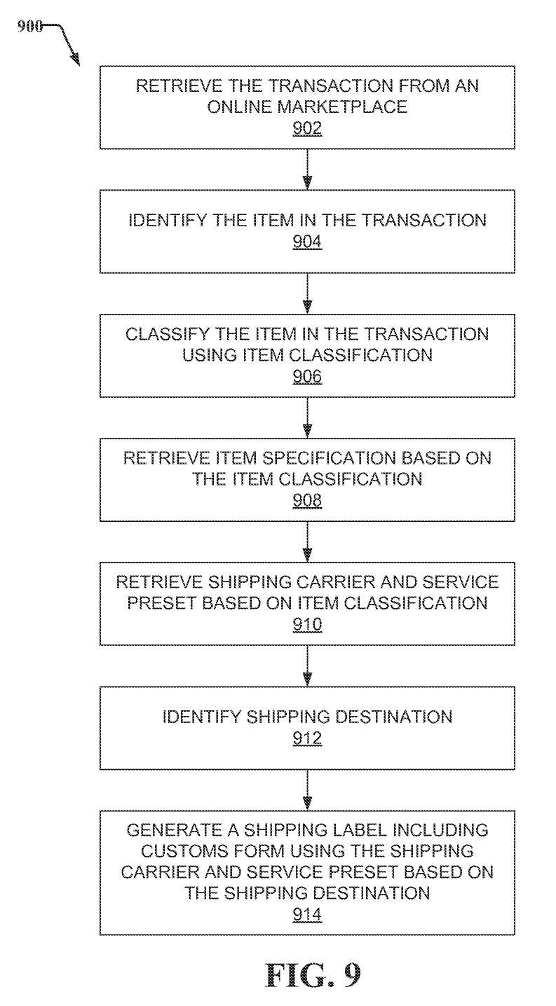

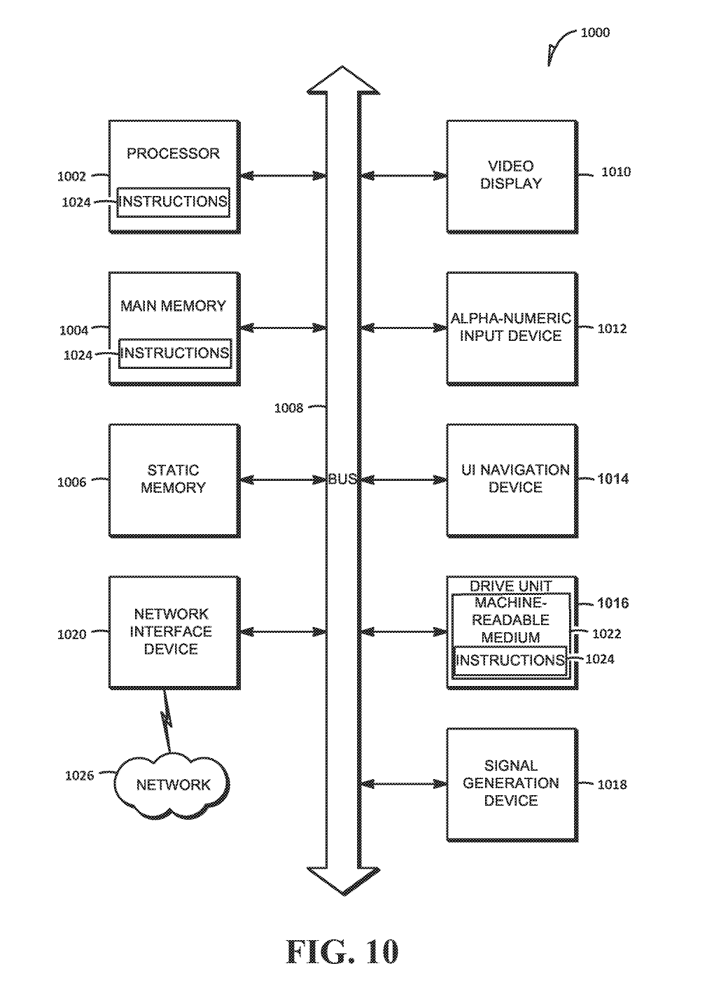

FIG. 9 is a flow diagram illustrating another example embodiment of a method 900 for a generating a shipping label. At operation 902, the transaction module 302 retrieves commercial transaction information from the marketplace application 120. At operation 904, the transaction module 302 identifies the item in the commercial transaction. At operation 906, the transaction module 302 classifies the item in the transaction using item classification previously defined by the seller.

At operation 908, the shipping preset preference module 304 retrieves item specification based on the item classification previously defined by the seller. At operation 910, the shipping preset preference module 304 retrieves shipping carrier and service preset based on the item classification. At 912, the shipping label generator 306 identifies shipping destination of the item and generates a shipping label including customs form using the shipping carrier and service preset based on the shipping destination.

### Example Computer System

FIG. 7 shows a diagrammatic representation of a machine in the example form of a computer system 700 within which a set of instructions 724 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 724 (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media.

The instructions 724 may further be transmitted or received over a network 726 via the network interface device 720 utilizing any one of a number of well-known transfer protocols (e.g., HTTP).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions 724. The term “machine-readable medium” 722 shall also be taken to include any medium that is capable of storing, encoding or carrying a set of instructions 724 for execution by the machine and that cause the machine to perform any one or more of the methodologies of the present disclosure, or that is capable of storing, encoding or carrying data structures utilized by or associated with such a set of instructions 724. The term “machine-readable medium” 722 shall accordingly be taken to include, but not be limited to, solid-state memories, optical media, and magnetic media.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hard ware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system, comprising:
a storage device configured to store a shipping preset preference corresponding to an item listed by a seller on the marketplace, the shipping preset preference identifying one of a plurality of shipping carriers and one of a plurality of shipping services selected by the seller for the item; and
a processor coupled to the storage device, the processor comprising a shipping label application configured to:
identify the item in a transaction of the seller in the marketplace,
retrieve the shipping preset preference of the seller corresponding to the item, and
generate a shipping label for the item based on the shipping preset preference.

2. The system of claim 1, wherein the processor further comprises a marketplace application configured to generate the transaction between a buyer and the seller in the marketplace for an item.

3. The system of claim 2, wherein the shipping label application further comprises:
a transaction module configured to access the transaction between the seller and the buyer from the marketplace application, the transaction identifying item information, seller information, buyer information, and sale information;
a shipping preset preference module configured to identify an item classification for the item, identify specifications of the item associated with the item classification, and identify one of a plurality of shipping carriers and one of a plurality of shipping services selected by the seller for the item;
a shipping label generator configured to generate the shipping label based on the item classification, specifications of the item, for the one of a plurality of shipping carriers and one of a plurality of shipping services selected by the seller for the item, in response to a single action being performed at a client of the seller.

4. The system of claim 3, wherein the item classification comprises an item group identifier and a group of identified items, wherein the item specifications are common to the items in the group of identified items, wherein the selected shipping carrier and shipping service are the same for the items in the group of identified items.

5. The system of claim 4, wherein the item specifications include a category of product.

6. The system of claim 3, wherein the shipping label generator is configured to include customs information based on the transaction between the buyer and the seller for the item in the shipping label.

7. The system of claim 5, wherein the customs information comprises a value of the item based on the sale information, a category of the item based on the item information, a description of the item based on the item information, and a country of origin based on the item information.

8. The system of claim 3, wherein the shipping label generator is configured to both identify the shipping preset preference of the seller corresponding to the item and generate the shipping label for the item based on the shipping preset preference, in response to the single action being performed at a client of the seller.

9. The system of claim 1, wherein the shipping label application is configured to identify a country of shipping destination for the item, a shipping carrier for the country of shipping destination for the item, and a shipping service of the shipping carrier.

10. The system of claim 9, wherein the shipping label application is configured to verify that the item is to be shipped cross-border based the country of shipping destination for the item, and to generate and include customs information using the transaction in the shipping label.

11. A computer-implemented method comprising:
storing a shipping preset preference corresponding to an item listed by a seller on the marketplace, the shipping preset preference identifying one of a plurality of shipping carriers and one of a plurality of shipping services selected by the seller for the item;
identifying the item in a transaction of the seller in the marketplace,
retrieving the shipping preset preference of the seller corresponding to the item; and
generating a shipping label for the item based on the shipping preset preference.

12. The computer-implemented method of claim 11, further comprising:
generating the transaction between a buyer and the seller in the marketplace for an item.

13. The computer-implemented method of claim 12, further comprising:
accessing the transaction between the seller and the buyer, the transaction identifying item information, seller information, buyer information, and sale information;
identifying an item classification for the item, identify specifications of the item associated with the item classification, and identify one of a plurality of shipping carriers and one of a plurality of shipping services selected by the seller for the item;
generating the shipping label based on the item classification, specifications of the item, for the one of a plurality of shipping carriers and one of a plurality of shipping services selected by the seller for the item, in response to a single action being performed at a client of the seller.

14. The computer-implemented method of claim 13, wherein the item classification comprises an item group identifier and a group of identified items, wherein the item specifications are common to the items in the group of identified items, wherein the selected shipping carrier and shipping service are the same for the items in the group of identified items.

15. The computer-implemented method of claim 14, wherein the item specifications include a category of product.

16. The computer-implemented method of claim 13, including customs information based on the transaction between the buyer and the seller for the item in the shipping label.

17. The computer-implemented method of claim 15, wherein the customs information comprises a value of the item based on the sale information, a category of the item based on the item information, a description of the item based on the item information, and a country of origin based on the item information.

18. The computer-implemented method of claim 13, further comprising:
identifying the shipping preset preference of the seller corresponding to the item and generating the shipping label for the item based on the shipping preset preference, in response to the single action being performed at a client of the seller.

19. The computer-implemented method of claim 11, identifying a country of shipping destination for the item, a shipping carrier for the country of shipping destination for the item, and a shipping service of the shipping carrier.

20. A non-transitory computer-readable storage medium storing a set of instructions that, when executed by a processor, cause the processor to perform operations, comprising:
storing a shipping preset preference corresponding to an item listed by a seller on the marketplace, the shipping preset preference identifying one of a plurality of shipping carriers and one of a plurality of shipping services selected by the seller for the item;
identifying the item in a transaction of the seller in the marketplace,
retrieving the shipping preset preference of the seller corresponding to the item; and
generating a shipping label for the item based on the shipping preset preference.
